(19) United States
(12) Patent Application Publication
(10) Pub. No.: US 2012/0258202 A1
(43) Pub. Date: Oct. 11, 2012

(54) Compositions and Methods for an Appetite Suppressant and a Nutrient Absorption Blocker with Treatment To Raise Metabolic Rate

(76) Inventor: Brian Cairns, New York, NY (US)

(21) Appl. No.: 13/441,866

(22) Filed: Apr. 7, 2012

Related U.S. Application Data
(60) Provisional application No. 61/473,210, filed on Apr. 8, 2011.

(51) Int. Cl. A23L 1/30; A23L 1/28; A23L 1/302

(52) U.S. Cl. 426/72

(57) ABSTRACT

Combining treatments to reduce caloric intake, such as an appetite suppressant and/or a nutrient absorption blocker with treatment to raise metabolic rate to compensate for its reduction due to caloric restriction. Enhancers focus upon the body's natural production of neurotransmitters, mainly serotonin and dopamine, and the body's efficiency in utilizing energy to increase the effectiveness of both treatments. Formulas are based on Green Tea extract, a standardized level of caffeine from coffee beans or coffee bean extract, a blend of B-vitamins, one of either of the following: coleus forskohlii extract, one of the following: 5-hydroxtryptophan or phenethylamine, and only specific formulas will include yohimbe bark extract standardized to 6% yohimbine or gugglesterones. Additional formulations combined with 2 g-5 g of any of the following glycomannans (fenugreek gum, tara gum, or locus bean gum) divided into two to three servings a day or the inclusion of reservatrol as a substitute for the galactomannan.

### CROSS REFERENCE TO RELATED APPLICATIONS

This application claims priority from U.S. Patent Application Ser. No. 61/473,210, entitled “Compositions and Methods for an Appetite Suppressant and a Nutrient Absorption Blocker with Treatment To Raise Metabolic Rate”, filed on 8 Apr. 2011. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to compositions and methods for promoting weight loss. More specifically, the present invention relates to compositions and method for an appetite suppressant and/or a nutrient absorption blocker with treatment to raise metabolic rate to compensate for its reduction due to caloric restriction.

### BACKGROUND OF THE INVENTION

Weight loss occurs when an individual is in a state of negative energy balance. A negative energy balance is achieved when the body exerts more energy (i.e. in work and metabolism) than it is consuming (i.e. from food or other nutritional supplements). When the body is in this state, it uses stored reserves from fat or muscle, which gradually leads to weight loss.

There are two ways that an individual can achieve a state of negative energy balance. The classical approach has been caloric restriction. In most cases, intentional weight loss is achieved with the help of diet since dietary restriction is generally more manageable than making a significant change in one's lifestyle. Although weight loss is generally associated with some degree of change in lifestyle habits, it is typically not as significant as adding a daily exercise regimen or beginning to practice a sport. As such, a wide variety of dietary strategies have been designed to meet the needs of individuals seeking to lose excess weight. Calorie-restriction strategies are one of the most common dietary plans. Daily calorie consumption for required varies depending upon, age, gender, and many more. The recommended minimum for women is 1,200 daily calories, while the recommendation for men, s can be as high as 1,500.

The challenge with achieving caloric restriction is controlling one's appetite. The appetite is the desire to eat food, felt as hunger. Appetite exists in all higher life-forms, and serves to regulate adequate energy intake to maintain metabolic needs. Appetite is regulated by a close interplay between the digestive tract, adipose tissue and the brain. The regulation of appetite (the appestat) has been the subject of much research in the last decade. Breakthroughs included the discovery of leptin in 1994, a hormone that appeared to provide negative feedback. Later studies showed that appetite regulation is an immensely complex process involving the gastrointestinal tract, numerous hormones, and both the central and autonomic nervous systems.

The American society has become ‘obesogenic,’ characterized by environments that promote increased food intake, unhealthy foods and physical inactivity. Policy and environmental change initiatives making healthy choices in nutrition and physical activity available, affordable, and easy will likely prove most effective in combating obesity.

The Division of Nutrition, Physical Activity, and Obesity (DNPAO) is working to reduce obesity and obesity-related conditions through state programs, technical assistance and training, leadership, surveillance and research, intervention development and evaluation, translation of practice-based evidence and research findings, and partnership development.

It is sad to note that 34% percent of adults age 20 years and over are obese, and an equal amount are overweight (2007-2008). Obesity is the leading preventable cause of death worldwide. With increasing prevalence in adults and children, authorities view obesity as one of the most serious public health problems of the 21^{st} century.

Dieting and physical exercise are the mainstays of maintaining a healthy weight. Moreover, it is important to improve diet quality by reducing the consumption of energy-dense foods such as those high in fat and sugars, and by increasing the intake of dietary fiber. Supplements such as the present invention can help by reducing the dieter's appetite while increasing his or her metabolic rate. Uncontrolled weight can lead to obesity, and obesity can lead to a number of co-morbidities and life-threatening conditions.

The object of the present invention is not to treat obesity, but to help those people who are overweight to maintain a negative caloric balance over a limited period as the shift to a more healthy lifestyle so they can avoid becoming obese.

### SUMMARY OF THE INVENTION

The present invention improves upon the existing art by combining a treatment to help reduce caloric intake, such as an appetite suppressant and/or a nutrient absorption blocker with a treatment to help raise metabolic rate in order to compensate for its reduction due to caloric restriction. In addition, the present invention improves upon the existing art by including with enhancers targeted to increase their effectiveness of both treatments. The enhancers focus upon enhancing the body's natural production of the neurotransmitters discussed above, mainly serotonin and dopamine, and the body's efficiency in utilizing energy.

The present invention covers combinations of the following dietary supplements. All formulas will have a base of Green Tea extract, a standardized level of caffeine from coffee beans or coffee bean extract, a blend of B-vitamins, one of either of the following: coleus forskohlii extract, one of the following: 5-hydroxtryptophan or phenethylamine, and only the maximum strength formulas will include yohimbe bark extract standardized to 6% yohimbine or gugglesterones. The present invention also covers any of the above formulations combined with 2 g-5 g of any of the following glycomannans (fenugreek gum, tara gum, or locus bean gum) divided into two to three servings a day.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a table illustrating a first formulation taught by the present invention;

FIG. 2 is a table illustrating a second formulation taught by the present invention;

FIG. 3 is a table illustrating a third formulation taught by the present invention;

FIG. 4 is a table illustrating a fourth formulation taught by the present invention;

FIG. 5 is a table illustrating a fifth formulation taught by the present invention;

FIG. 6 a table illustrating the summary of ingredient proposed metabolic effects of the formulations of the present invention;

FIG. 7 is a chart illustrating initial trial final results of weight loss over time based on use of the present invention;

FIG. 8 is a chart illustrating initial trial final results of absolute pounds lost over time based on use of the present invention;

FIG. 9 is a chart illustrating Data Demonstrating the Synergic Effects of the Formula vs. the Component Parts based on the final results of the initial trial; and

FIG. 10 is a chart illustrating actual weight loss versus average caloric balance.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the present invention.

The hypothalamus is the target of hunger and satiety signals arising from the peripheral organs and the brain. Noradrenaline-neuropeptide Y and opioid-galanine are involved in carbohydrate and fat intake, respectively, while serotonin-CCK-insulin and dopamine-cyclic dipeptides systems inhibit them. The somatic processes controlled by the hypothalamus include vagal tone (the activity of the parasympathetic autonomic nervous system), stimulation of the thyroid (thyroxine regulates the metabolic rate), the hypothalamic-pituitary-adrenal axis and a large number of other mechanisms. Opioid receptor-related processes in the nucleus accumbens and ventral pallidum affect the palatability of foods.

Catecholamines and their derivatives (such as amphetamine-based drugs) have been the main tools used for controlling appetite historically. These appetite suppressants can be further sub-divided, based on the neurotransmitters on which they are believed to exert their effects. Medications have been prescribed for their ability to suppress appetite for over half a century. The first prescription appetite suppressants were the sympathomimetic amphetamine derivatives, so described because they exert their effects by stimulating the sympathetic nervous system. Some of the newer appetite suppressants exert their effects by mimicking the sympathetic nervous system.

Sibutramine is a combined norepinephrine and serotonin reuptake inhibitor. Its putative effect on weight loss is attributed to appetite suppression and increased thermogenesis, secondary to stimulation of brown adipose tissue. Sibutramine was approved for use in conjunction with a low calorie diet as an aid to weight loss in 1998.

Fluoxetine is a selective serotonin reuptake inhibitor (SSRI) that was originally approved to treat depression. The original manufacturer submitted an New Drug Application for use of fluoxetine as a weight loss drug in the early 1990s; however, approval was not given, and the application was eventually withdrawn.

Sertraline, like fluoxetine, is a SSRI. In the early 1990s, it was noted that sertraline administered to laboratory animals resulted in weight loss.

Phentermine is a sympathomimetic amine of the β-phenethylamine family. It was approved for use by the FDA in 1959 as a short term aid to weight loss in conjunction with a low calorie diet and exercise. Unlike use of sibutramine, use of phentermine leads to the development of tolerance.

Diethylpropion, like phentermine, is a sympathomimetic agent prescribed for short-term weight loss when used in conjunction with diet and exercise. Diethylpropion is similar in chemical structure to bupropion, which is approved as an antidepressant and as a smoking cessation aid and has also been tested as a weight loss aid.

A study conducted by the Agency for Healthcare Research and Quality reviewed efficacy and safety of the following medications used for weight loss: sibutramine, orlistat, fluoxetine, phentermine, Diethylpropion, bupropion, zonisamide, topiramate, and sertraline. Most of the medications discussed work by suppressing the appetite. The mean placebo-corrected weight loss for all drugs was less than 5 kg at one year. Total weight loss at one year was higher, up to 8.0 kg. However, as noted in the introduction, even moderate weight loss (5 percent of body weight) can significantly influence obesity-associated risk factors for poor health outcomes Other chemicals in this class, but not mentioned in the study because they are not drugs include: dopamine, norepinephrine, epinephrine.

Although these drugs have shown to have a modest effect, they do come with varying degrees of side-effects. Sibutramine appears to have the most serious, while Phentermine appears to be the best tolerated. A higher number of cardiovascular events have been observed in people taking sibutramine versus control (11.4% vs. 10.0%). In 2010 the FDA noted the concerns that sibutramine increases the risk of heart attacks and strokes in patients with a history of cardiovascular disease, which has led to its withdrawal from the market. Among the common adverse effects associated with fluoxetine and listed in the prescribing information, the effects with the greatest difference from placebo are nausea (22% vs 9% for placebo), insomnia (19% vs 10% for placebo), somnolence (12% vs 5% for placebo), anorexia (10% vs 3% for placebo), and anxiety (12% vs 6% for placebo). Those that most often resulted in interruption of the treatment were anxiety, insomnia, and nervousness (1-2% each). Sertraline shares the common side effects and contraindications of other SSRIs, with high rates of nausea, diarrhea, insomnia, and sexual side effects; however, its effects on cognition are mild. Diethylpropion has a low, but not insignificant abuse potential, and thus, it is a schedule IV compound in the US, which restricts its use.

Beyond the methods noted above, limiting the absorption of key macronutrients, i.e. fats, carbohydrates, and/or proteins is another way to reduce caloric intake.

The marketed product ALII, which goes by the generic name ORLISTAT, is a key example of this concept. ORLISTAT is known as tetrahydrolipstatin, is a drug designed to treat obesity. Its primary function is preventing the absorption of fats from the human diet, thereby reducing caloric intake. Fats contain the highest caloric value of the major macro nutrients; however, halting the absorption of fats has unpleasant side-effects if too much fat is consumed. The effectiveness of orlistat in promoting weight loss is definite, though modest. Pooled data from clinical trials suggest that people given orlistat in addition to lifestyle modifications, such as diet and exercise, lose about 2-3 kilograms (4.4-6.6 lb) more than those not taking the drug over the course of a year.

The effect of ORLISTAT is modest and comes with unpleasant side effects. The primary side effects of the drug are gastrointestinal-related, and include steatorrhea (oily, loose stools with excessive flatus due to unabsorbed fats reaching the large intestine), fecal incontinence and frequent or urgent bowel movements. GLAXOSMITHKLINE recommends that all users be cautious of the possible side effects until they “have a sense of any treatment effects. To minimize these effects, foods with high fat content should be avoided; the manufacturer advises consumers to follow a low-fat, reduced-calorie diet. Oily stools and flatulence can be controlled by reducing the dietary fat content to somewhere in the region of 15 grams per meal. The manual for Alli makes it clear that orlistat treatment involves aversion therapy, encouraging the user to associate eating fat with unpleasant treatment effects. After ORLISTAT was stopped, a significant number of subjects regained weight—up to 35% of the weight they had lost. he absorption of fat-soluble vitamins and other fat-soluble nutrients is inhibited by the use of orlistat. A multivitamin tablet containing vitamins A, D, E, K, and beta-carotene should be taken once a day, at bedtime, when using orlistat.

A different approach would be to target carbohydrates. Fenugreek (foenum graecum) exerts antidiabetic effects mediated through inhibition of carbohydrate digestion and absorption, and enhancement of peripheral insulin action in rats. One Study showed in man the immediate positive effect of all the above herbal teas [including fenugreek] in reducing the postprandial glycemic response of bread. Fenugreek is part of a class of compounds called Galactomannans.

Galactomannans are polysaccharides consisting of a mannose backbone with galactose side groups (more specifically, a (1-4)-linked beta-D-mannopyranose backbone with branchpoints from their 6-positions linked to alpha-D-galactose, i.e. 1-6-linked alpha-D-galactopyranose). Based upon the similarities in chemical structure, the present invention hypothesizes that the galactomannans: guar gum, tara gum, and locust bean gum will have the same impact on glucose absorption. By reducing the amount adsorbed, it is theorized that the total caloric intake can be lessened leading to a negative energy balance.

In addition, the galactomannans may offer an addition benefit of increasing the viscosity of the gastric medium, which in turn, should slow the transit time through the stomach. By slowing its transit time, it should lengthen the time a person feels “full”. When food eaten by test animals was allowed to drain from open gastric cannulas, meal termination is delayed, and the animals feed continuously. In contrast, if the animals are offered the same diet, when the cannulas are closed, the rate of ingestion slows and all but stopped in 15 min. Clinical experiments strongly support the conclusion that gastric feedback is cause by mechanical stimuli, e.g. distention. By slowing the transit time, it is theorized that it would extend the duration of the mechanical stimuli, leading to a reduction in caloric intake.

The challenge with any of the above approaches is the sole focus on caloric restriction, and thus, it is proposed that they solve only part of the problem. Research has shown that there is a positive relation between the reduction in thermogenesis (Basal Metabolic Rate, aka BMR) and the degree of fat mass depletion. This suggests that the adaptive reduction in BMR is partly determined by an autoregulatory feedback control system linking the state of depletion of fat stores to compensatory mechanisms that suppress thermogenesis. This feedback mechanism may explain why these medications alone have had limited effectiveness.

The primary organ responsible for regulating metabolism is also the hypothalamus. The chief functions of the hypothalamus, which pertain to the inventions, are: control the activities of the central nervous system, heart rate, etc.; regulation of body temperature; and regulation of food intake, as discussed.

The present invention focuses on the regulation of body temperature and enhancing the metabolic efficiency. The other means of increasing BMR is to increase the amount of lean muscle mass. Muscle mass burns more calories than other tissues.

The present invention improves upon the existing art by combining a treatment to help reduce caloric intake, such as an appetite suppressant and/or a nutrient absorption blocker with a treatment to help raise metabolic rate in order to compensate for its reduction due to caloric restriction. In addition, the present invention improves upon the existing art by including with enhancers targeted to increase their effectiveness of both treatments. The enhancers focus upon enhancing the body's natural production of the neurotransmitters discussed above, mainly serotonin and dopamine, and the body's efficiency in utilizing energy.

The present invention covers combinations of the following dietary supplements. All formulas will have a base of Green Tea extract, a standardized level of caffeine from coffee beans or coffee bean extract, a blend of B-vitamins, one of either of the following: coleus forskohlii extract, one of the following: 5-hydroxtryptophan or phenethylamine, and only the maximum strength formulas will include yohimbe bark extract standardized to 6% yohimbine or gugglesterones. The present invention also covers any of the above formulations combined with 2 g-5 g of any of the following glycomannans (fenugreek gum, tara gum, or locus bean gum) divided into two to three servings a day. The present invention also covers the inclusion of reservatrol as a substitute for the galactomannan.

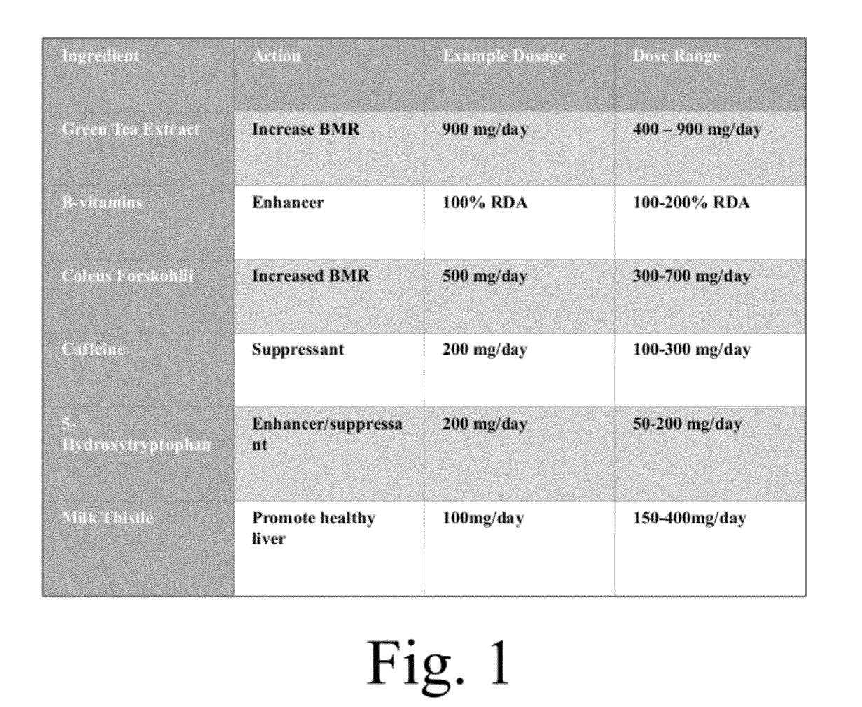

Now referring to FIGS. 1-5, several examples of typical formulations included but not limited to in this patent application are disclosed. Each formulation calls out the target and the range covered by the formulation taught by the present invention.

In the first formulation illustrated in FIG. 1, the formulation contains: Green Tea Extract (standardized EGCG 50%) provided in an amount of 900 mg/day with a dose range of 400-1,400 mg/day used to increase BMR; B-vitamins in an amount of 1.1-1.2 mg/day of thiamin, 1.1-1.3 mg/day of riboflavin, and 14-16 mg/day of niacin with a dose range of 0.6-1.8 mg/day of thiamin, 0.6-1.8 mg/day of riboflavin, and 8-24 mg/day of niacin used as an enhancer; Coleus Forskohlii (4:1, 10:1 ethanol/water, or standardized 10% forskolin) in an amount of 500 mg/day with a dose range of 250-750 mg/day used to increase BMR; Caffeine from coffee beans or coffee bean extract in the amount of 200 mg/day with a dose range of 100-300 mg/day used as a suppressant; 5-Hydroxytryptophan in an amount of 200 mg/day with a dose range of 100-300 mg/day used as an enhancer and suppressant; and Milk Thistle standardized at 80% silymarin in an amount of 300 mg/day with a dose range of 150-450 mg/day used to promote a healthy liver.

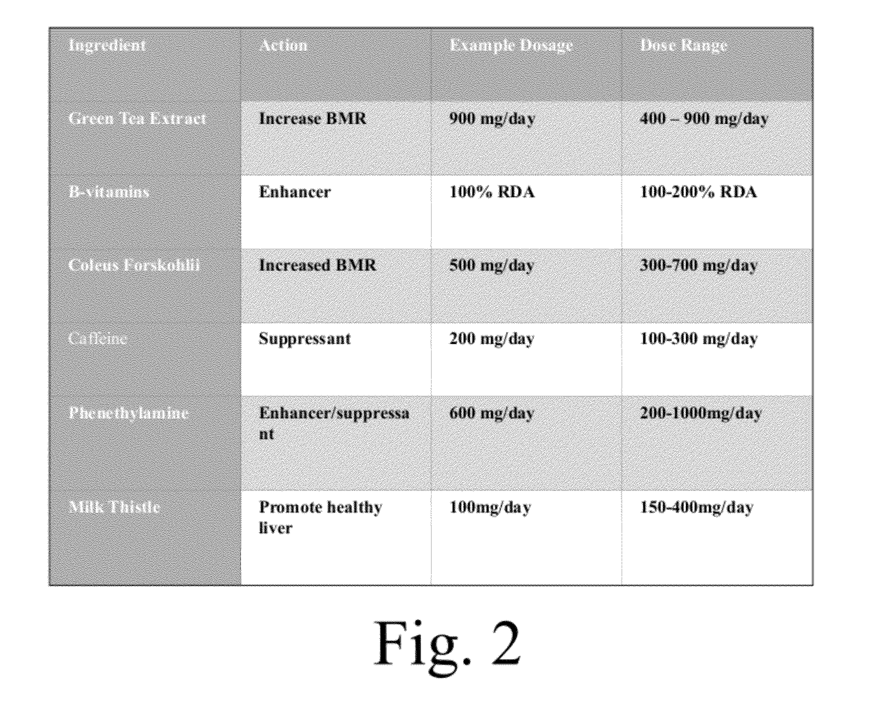

In the second formulation illustrated in FIG. 2, the formulation contains: Green Tea Extract (standardized 50% EGCG) provided in an amount of 900 mg/day with a dose range of 400-1,400 mg/day used to increase BMR; B-vitamins in an amount of 1.1-1.2 mg/day of thiamin, 1.1-1.3 mg/day of riboflavin, and 14-16 mg/day of niacin with a dose range of 0.6-1.8 mg/day of thiamin, 0.6-1.8 mg/day of riboflavin, and 8-24 mg/day of niacin used as an enhancer; Coleus Forskohlii (4:1, 10:1 ethanol/water, or standardized 10% forskolin) in an amount of 500 mg/day with a dose range of 250-750 mg/day used to increase BMR; Caffeine from coffee beans or coffee bean extract in the amount of 200 mg/day with a dose range of 100-300 mg/day used as a suppressant; Phenethylamine in an amount of 600 mg/day with a dose range of 200-1000 mg/day used as an enhancer and suppressant; and Milk Thistle in an amount of 300 mg/day with a dose range of 150-450 mg/day used to promote a healthy liver.

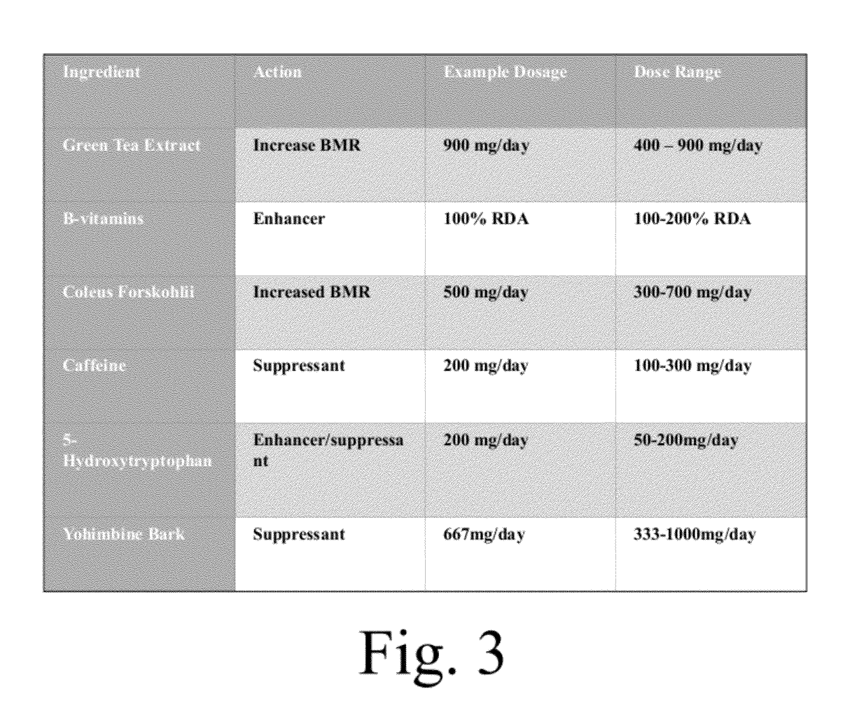

In the third formulation illustrated in FIG. 3, the formulation contains: Green Tea Extract (standardized 50% EGCG) provided in an amount of 900 mg/day with a dose range of 400-1,400 mg/day used to increase BMR; B-vitamins in an amount of 1.1-1.2 mg/day of thiamin, 1.1-1.3 mg/day of riboflavin, and 14-16 mg/day of niacin with a dose range of 0.6-1.8 mg/day of thiamin, 0.6-1.8 mg/day of riboflavin, and 8-24mg/day of niacin used as an enhancer; Coleus Forskohlii (4:1, 10:1 ethanol/water, or standardized 10% forskolin) in an amount of 500 mg/day with a dose range of 250-750 mg/day used to increase BMR; Caffeine from coffee beans or coffee bean extract in the amount of 200 mg/day with a dose range of 100-300 mg/day used as a suppressant; 5-Hydroxytryptophan in an amount of 200 mg/day with a dose range of 100-300 mg/day used as an enhancer and suppressant; and Yohimbe Bark (standardized 6% yohimbine) in an amount of 667 mg/day with a dose range of 333-1000 mg/day used as a suppressant.

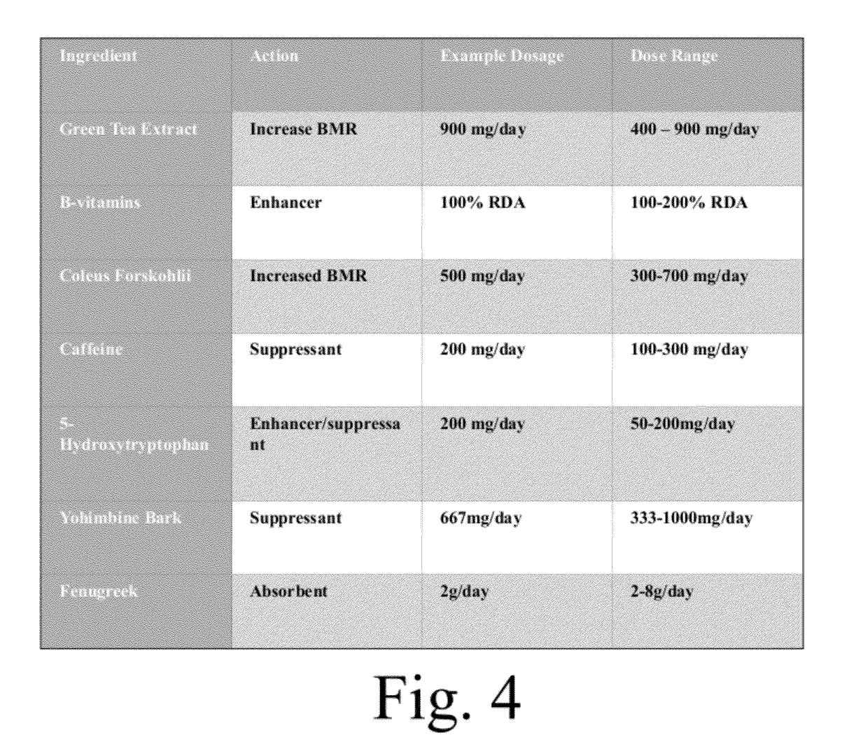

In the fourth formulation illustrated in FIG. 4, the formulation contains: Green Tea Extract provided in an amount of 900 mg/day with a dose range of 400-1,400 mg/day used to increase BMR; B-vitamins in an amount of 1.1-1.2 mg/day of thiamin, 1.1-1.3 mg/day of riboflavin, and 14-16 mg/day of niacin with a dose range of 0.6-1.8 mg/day of thiamin, 0.6-1.8 mg/day of riboflavin, and 8-24 mg/day of niacin used as an enhancer; Coleus Forskohlii (4:1, 10:1 ethanol/water, or standardized 10% forskolin) in an amount of 500 mg/day with a dose range of 250-750 mg/day used to increase BMR; Caffeine from coffee beans or coffee bean extract in the amount of 200 mg/day with a dose range of 100-300 mg/day used as a suppressant; 5-Hydroxytryptophan in an amount of 200 mg/day with a dose range of 100-300 mg/day used as an enhancer and suppressant; Yohimbe Bark in an amount of 667 mg/day with a dose range of 333-1000 mg/day used as a suppressant; and Fenugreek in an amount of 2 g/day with a dose range of 2-8 g/day used as an absorbent.

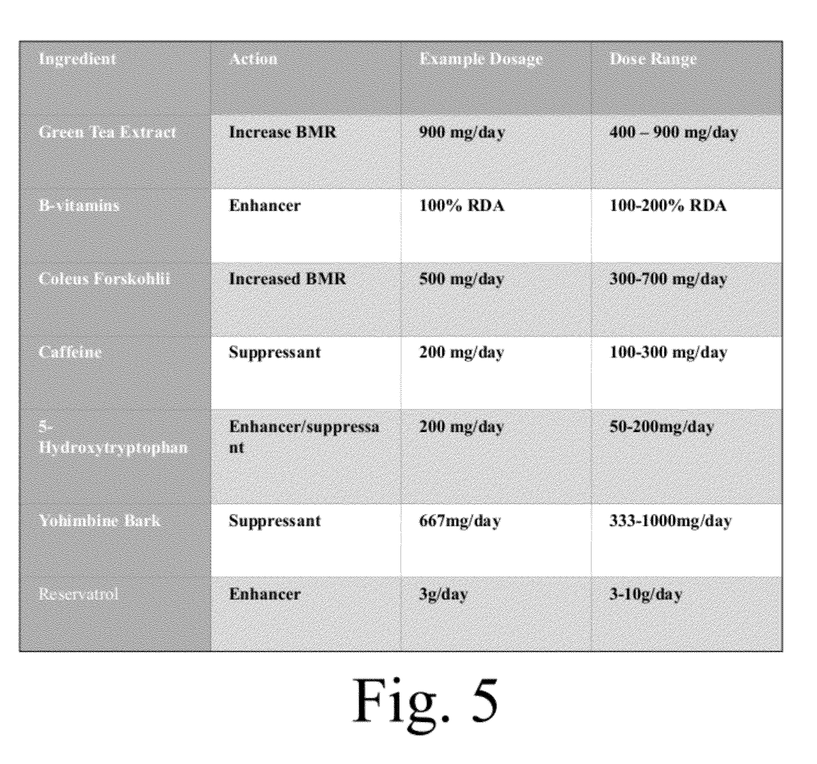

In the fifth formulation illustrated in FIG. 5, the formulation contains: Green Tea Extract (standardized 50% EGCG) provided in an amount of 900 mg/day with a dose range of 400-1,400 mg/day used to increase BMR; B-vitamins in an amount of 1.1-1.2 mg/day of thiamin, 1.1-1.3 mg/day of riboflavin, and 14-16 mg/day of niacin with a dose range of 0.6-1.8 mg/day of thiamin, 0.6-1.8 mg/day of riboflavin, and 8-24 mg/day of niacin used as an enhancer; Coleus Forskohlii (4:1, 10:1 ethanol/water, or standardized 10% forskolin) in an amount of 500 mg/day with a dose range of 250-750 mg/day used to increase BMR; Caffeine from coffee beans or coffee bean extract in the amount of 200 mg/day with a dose range of 100-300 mg/day used as a suppressant; 5-Hydroxytryptophan in an amount of 200 mg/day with a dose range of 100-300 mg/day used as an enhancer and suppressant; Yohimbe Bark in an amount of 667 mg/day with a dose range of 333-1000 mg/day used as a suppressant.

In alternative embodiments, each of the above five formulations could be divided into a plurality of doses per day. In a preferred embodiment, each of the above five formulations would be divided into two or three doses per day.

The Green Tea Extract is provided with total catechin content ranging from 300 mg to 900 mg/day in divided doses of 2 or 3. They can also be called green tea polyphenols (GTP or GTPs). The category includes epigallocatechin gallate (EGCG), epigallocatechin (EGC), epicatechin gallate (ECG) and epicatechin (EC). Of which, EGCG is standardized and accounts for 50% or more of the total content.

Clinical trials conducted by the University of Geneva and the University of Birmingham indicate that green tea raises metabolic rates, speeds up fat oxidation and improves insulin sensitivity and glucose tolerance. The present invention uses a reduced caffeine from coffee beans or coffee bean extract extract. The caffeine from coffee beans or coffee bean extract is added later as a separate ingredient to ensure consistency. Green tea contains catechin polyphenols that raise thermogenesis (the production of heat by the body), and hence increases energy expenditure. There is also a suggestion that it can increase endurance in exercise by improving fat metabolism.

Catechins or an epigallocatechin gallate (EGCG)-caffeine mixture have a small positive effect on weight loss and weight managment In one study, extra high-catechin GT1 (458 mg catechins, 104 mg caffeine/day), two servings of a high-catechin GT2 (468 mg catechins, 126 mg caffeine/day) or two servings of the extra high-catechin GT3 (886 mg catechins, 198 mg caffeine/day) were given for 90 days. Data were collected at 0, 30, 60, and 90 days. A decrease in estimated intra-abdominal fat (IAF) area of 5.6 square centimeters in the GT3 group was observed. In addition, decreases of 1.9 cm in waist circumference and 1.2 kg body weight in the GT3 group vs. C (P<0.05) were found. Reductions in total body fat (GT2, 0.7 kg, P<0.05) and body fat % (GT1, 0.6%, P<0.05) were observed. The study concluded that consumption of two servings of an extra high-catechin GT leads to improvements in body composition and reduces abdominal fatness in moderately overweight Chinese subjects. Findings suggest that green tea catechin consumption enhances exercise-induced changes in abdominal fat and serum triglycerides.

The B-Vitamins, including Niacin, Thiamin, and Riboflavin, are provided with or without vitamin B-6, at the 0.6-1.8 mg/day of thiamin, 0.6-1.8 mg/day of riboflavin, and 8-24 mg/day of niacin. Niacin is a precursor to NAD+/NADH and NADP+/NADPH, which play essential metabolic roles in living cells. Niacin is involved in both DNA repair, and the production of steroid hormones in the adrenal gland. Mild niacin deficiency has been shown to slow metabolism, causing decreased tolerance to cold. Thiamin is a water-soluble vitamin of the B complex. Its phosphate derivatives are involved in many cellular processes. Thiamine diphosphate (ThDP), also known as thiamine pyrophosphate (TPP) or cocarboxylase, is catalyzed by an enzyme called thiamine diphosphokinase according to the reaction thiamine+ATP→ThDP+AMP (EC 2.7.6.2). ThDP is a coenzyme for several enzymes that are all important in carbohydrate metabolism. Riboflavin is an easily absorbed micronutrient with a key role in maintaining health in humans. It is the central component of the cofactors FAD and FMN, and is therefore required by all flavoproteins. As such, vitamin B2 is required for a wide variety of cellular processes. It plays a key role in energy metabolism, and for the metabolism of fats, ketone bodies, carbohydrates, and proteins.

Riboflavin is continuously excreted in the urine of healthy individuals, making deficiency relatively common when dietary intake is insufficient. However, riboflavin deficiency is always accompanied by deficiency of other vitamins. Vitamin B-6, pyridoxal phosphate, the metabolically active form of vitamin B6, is involved in many aspects of macronutrient metabolism, neurotransmitter synthesis. PLP is also used to create physiologically active amines by decarboxylation of amino acids. Some notable examples of this include: histidine to histamine, tryptophan to serotonin, glutamate to gamma-aminobutyric acid (GABA), and dihydroxyphenylalanine to dopamine.

Coleus Forskohlii Extract is provided covering 4:1, 5:1, 10:1 extractions, as well as, standardized extractions of 10% forskolin at doses ranging from 250-750 mg/d. Forskolin is commonly used to raise levels of cyclic AMP (cAMP) in the study and research of cell physiology. Forskolin resensitizes cell receptors by activating the enzyme adenylyl cyclase and increasing the intracellular levels of cAMP. cAMP is an important signal carrier necessary for the proper biological response of cells to hormones and other extracellular signals. It is required for cell communication in the hypothalamus/pituitary gland axis and for the feedback control of hormones. cAMP and its associated kinases function in several biochemical processes, including the regulation of glycogen, sugar, and lipid metabolism. Oral ingestion of forskolin (250 mg of 10% forskolin extract twice a day) for a 12-week period was shown to favorably alter body composition by increase lean mass.

Guggulsterones are provided with a range of 1-2 g/day of extract (typically 2.5-5.0% guggulsterones). Guggulsterones are plant steroids found in the resin of the guggul plant, Commiphora mukul. Guggulsterone can exist as either of two stereoisomers, E-guggulsterone and Z-guggulsterone. In humans, it acts as an antagonist of the farnesoid X receptor, which was once believed to result in decreased cholesterol synthesis in the liver. In one study, Body weight decreased significantly in the experimental group (3.2%, P<0.05) and fat mass decreased significantly in the experimental (20.6%) and control (8.6%) groups (P<0.01). However, between-group differences in weight loss were not statistically significant. Profile of Mood States (POMS)-fatigue decreased significantly in the experimental group (63.7%, P<0.01), whereas POMS-vigor increased significantly in the experimental group (32.3%, P<0.01) and decreased significantly in the placebo group (15.6%, P<0.01). Results of this study suggest that ingestion of a guggulsterone phosphate salt compound concurrent with regular exercise will result in a significant loss of body weight and improved mood states Guggulsterone-Z has been shown to stimulate the thyroid, which may explain its impact on increasing metabolic rate.

Caffeine from coffee beans or coffee bean extract is provided with a range of 50-150 mg/dose up to 100-300 mg/day. Caffeine is a phosphodiesterase inhibitor. Phosphodiesterase inhibitors inhibit cAMP-phosphodiesterase (cAMP-PDE) enzymes, which convert cyclic AMP (cAMP) in cells to its noncyclic form, thus allowing cAMP to build up in cells. Cyclic AMP participates in activation of protein kinase A (PKA) to begin the phosphorylation of specific enzymes used in glucose synthesis. By blocking its removal, caffeine intensifies and prolongs the effects of epinephrine and epinephrine-like drugs such as amphetamine, methamphetamine, and methylphenidate. Metabolites of caffeine also contribute to caffeine's effects. Paraxanthine is responsible for an increase in the lipolysis process, which releases glycerol and fatty acids into the blood to be used as a source of fuel by the muscles. Theobromine is a vasodilator that increases the amount of oxygen and nutrient flow to the brain and muscles.

5-Hydroxytryptophan (5-HTP) is provided with a range of 100-900 mg/day. 5-HTP is a naturally-occurring amino acid and chemical precursor as well as metabolic intermediate in the biosynthesis of the neurotransmitters serotonin and melatonin from tryptophan. The psychoactive action of 5-HTP 15 derived from its effect on the production of serotonin in central nervous system tissue. More specifically, 5-HTP increases the production of serotonin.

Phenethylamine (PEA) is provided with a range of 200-1000 mg/day. PEA is naturally occurring monoamine alkaloid. It is biosynthesized from the amino acid phenylalanine by enzymatic decarboxylation. Besides mammals, PEA is found in many other organisms and foods such as chocolate, especially after microbial fermentation. It is sold as a dietary supplement for purported mood and weight loss-related therapeutic benefits; however, orally ingested PEA is usually inactive on account of extensive first-pass metabolism by monoamine oxidase (MAO) into phenylacetic acid, preventing significant concentrations from reaching the brain. PEA, similarly to amphetamine, acts as a releasing agent of norepinephrine and dopamine.

Yohimbe Bark extract (Pausinystalia yohimbe) is provided with a range of 333-1000 mg/day standardized 6% yohimbine. Yohimbine is a α-1 & α-2 receptor antagonist, and is the main active constituent of the ground bark of P. yohimbe. A review article identified 3 double-blind RCTs, which included patients who were greater than 15-20% over their ideal weight. Those trials report conflicting results According to one study, oral yohimbine supplementation may actuate significant fat loss in athletes. Activation of α₁-adrenergic produces anorexia and partially mediates the efficacy of appetite suppressants like phenylpropanolamine and amphetamine in the treatment of obesity. The chemical class of catecholamines has been shown to help suppress appetite as outlined above. Beta-adrenergic activity suppresses transcription of LPL in adipocytes; this phenomenon may contribute to the favorable impact of exercise training on visceral obesity; conceivably, preadministration of safe drugs that boost catecholamine activity (caffeine, yohimbine) could potentiate this beneficial effect of exercise.

Galactomannans are provided with a range of 1-8 g/day. Fenugreek has the most data to support its theorized effect on carbohydrate absorption. It is believed that both Locust Bean Gum and Tara Gum will exhibit the same effect.

Milk Thistle extract (Silybum marianum) is provided with a range of 150-450 mg/day standardized 80% silymarin. In clinical studies, Milk Thistle has been shown to have a positive hepatoprotective effect in the treatment of liver cirrhosis associated with chronic alcohol abuse or viruses. In animal, in vitro, and clinical studies, the primary action of silymarin as an antioxidant is a protectant for the kidneys and liver. The compounds in the extract seem to inhibit the entrance of toxins and block toxin binding sites through alteration of the liver cell's outer membrane. Silibinin decreases production of superoxide anion radicals and nitric oxide (free-radical scavenger or antioxidant) by the Kupffer cells. Silibinin also inhibits leukotriene formation. Silymarin increases glutathione production by the liver, intestines, and stomach. Glutathione is used for detoxification cells in the liver.

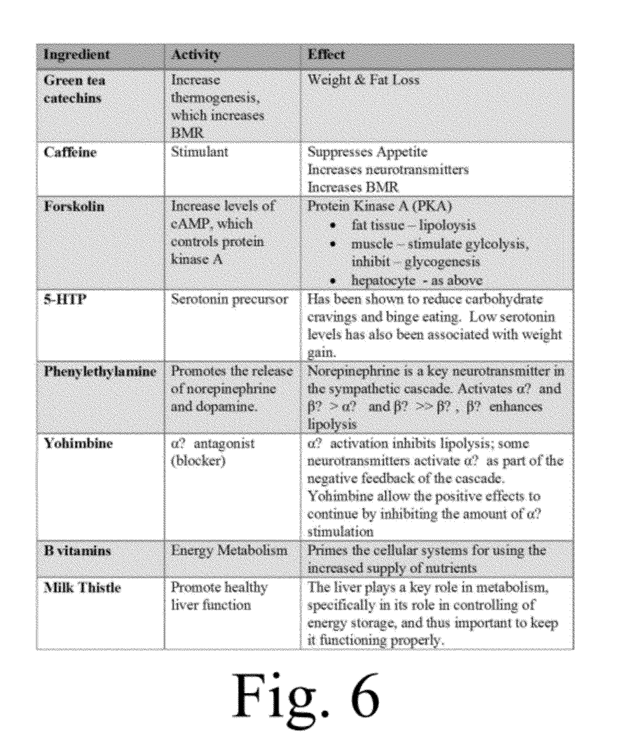

The formulations taught above enhance the BMR as a means to potentiate the effectiveness of caloric restriction. This is accomplished by combining a treatment to help reduce caloric intake, such as an appetite suppressant and/or a nutrient absorption blocker with a treatment to help raise metabolic rate in order to compensate for its reduction due to caloric restriction. The enhancers taught by the present invention focus upon enhancing the body's natural production of the neurotransmitters discussed above, mainly serotonin and dopamine, and the body's efficiency in utilizing energy. FIG. 6 is a table illustrating the summary of ingredient proposed metabolic effects of the formulations of the present invention. 5-HTP and PEA are precursors to the neurotransmitters involved in the modulation of appetite and weight gain, most notably, serotonin and dopamine, which have been shown to play a role in appetite suppression.

Adding a blend of B-vitamins that are associated with cellular metabolism ensures that sufficient amounts of key vitamins are readily available to maximize the effect of the metabolic rate enhancement by the other ingredients. The addition of B-6 can help with the in-vivo conversion of 5-HTP to serotonin, thereby potentiating its effect. By adding of either glycomannans or reservatrol to help inhibit glucose absorption the formulation works synergistically with the appetite suppression and metabolic enhancement to maximize the present inventions' chances to deliver a consistent negative energy balance.

The body is primed to use energy, which is why B vitamins were added. Exercise should be more efficient. The question is by how much, which is an unknown.

Increase in muscle mass increases BMR. Both yohimbine and forskolin may have a positive effect on body composition, and if so, the formula should be able to increase BMR with increasing lean mass.

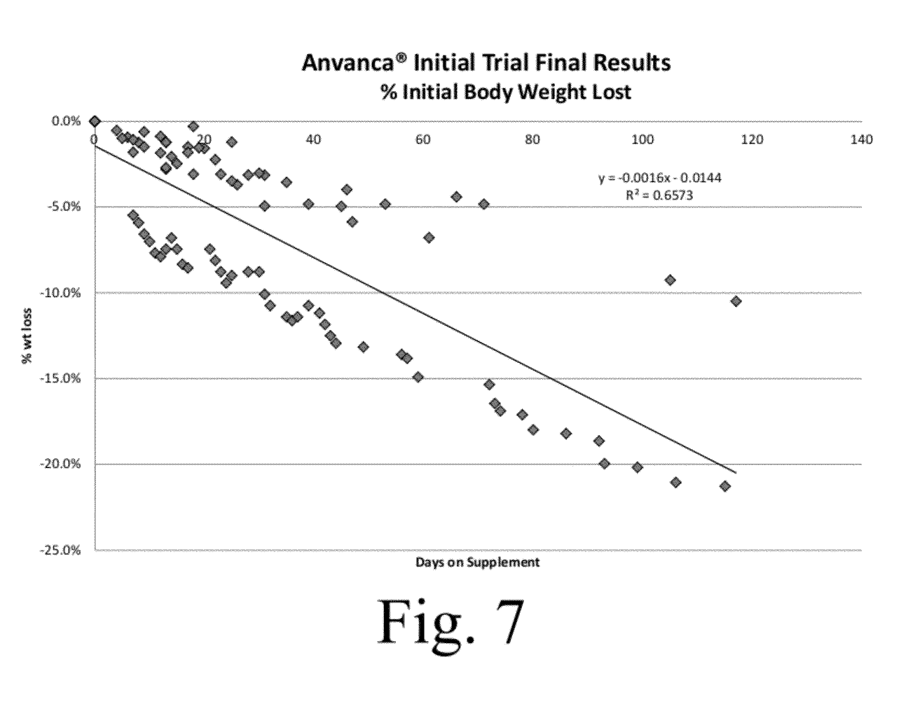

Now referring to FIGS. 7-10, unexpected results from the use of the formulations taught by the present invention are show. The results are not broken out based upon formula.

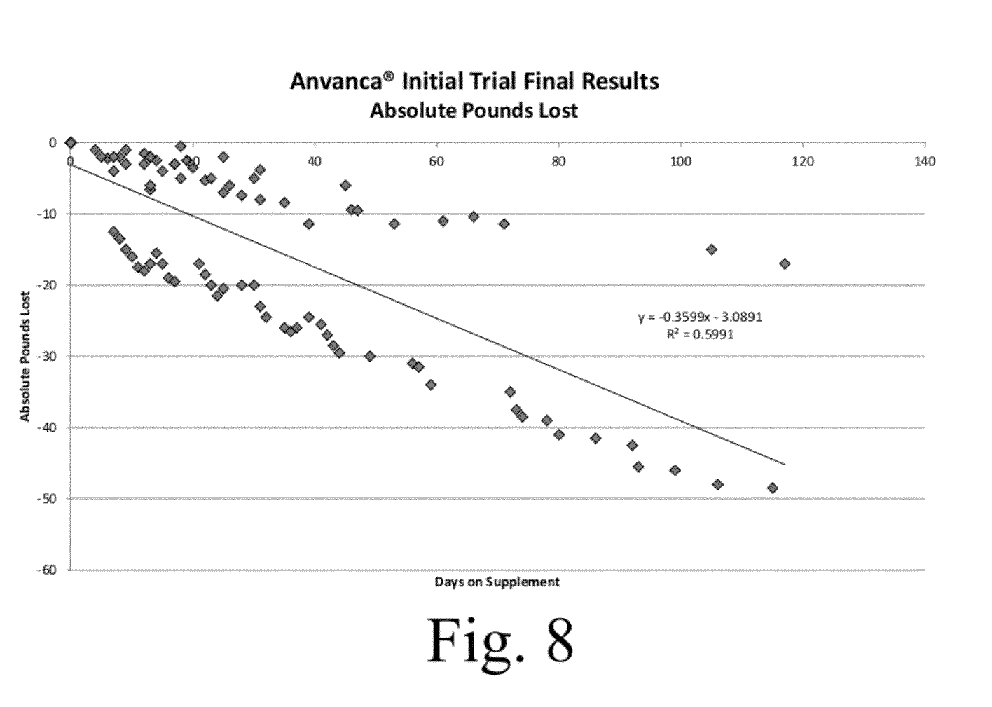

The results are more than one would expect from the “sum of the parts” of the ingredients selected for use in the formulations taught by the present invention. FIG. 7 is a chart of the percentage of weight loss versus the number of days on the supplement for ANVANCA. FIG. 8 is a chart of the percentage of weight loss versus the number of days on the supplement Act.

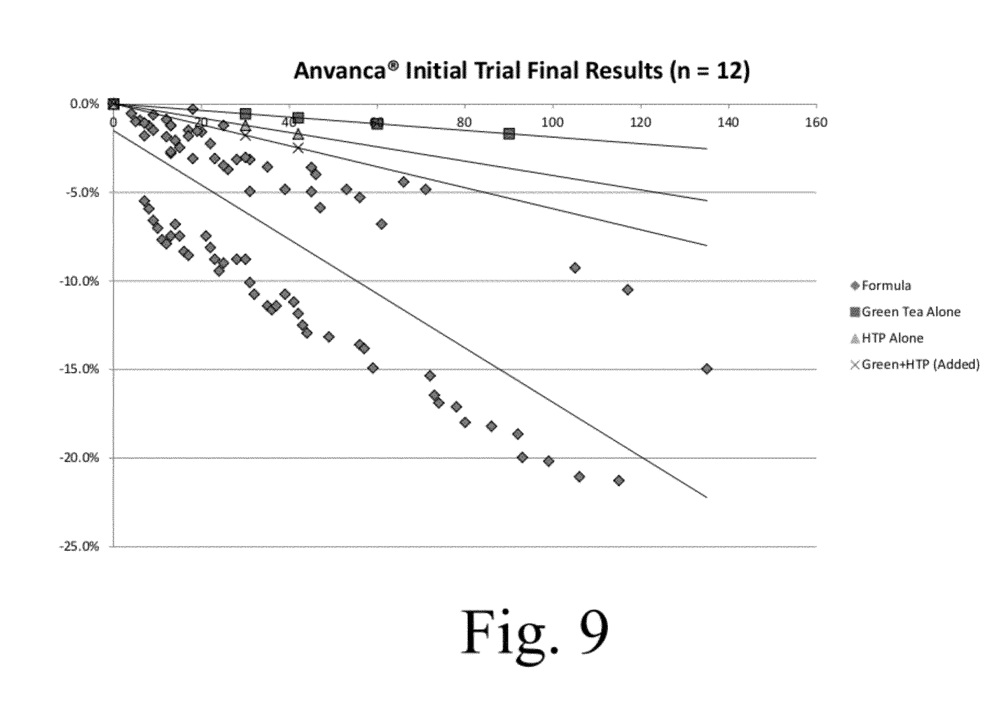

FIG. 9 is a chart of the percentage of weight loss versus the number of days on the supplement for the supplement taught and claimed by the present invention, also referred to as ANVANCA, its trademarked name. In this chart, the diamonds represent the percentage of weight loss over time when using the formula of the present invention while the squares represent weight loss over time for green tea alone, the triangles for HTP alone, and the x's green tea with HTP added. Again, the results are more than one would expect from the “sum of the parts” of the ingredients selected for use in the formulations taught by the present invention and in comparison to those known in the prior art to be used for weight loss. Given their different mechanisms of action, the results are not the summation of the mere combination of the selected ingredients, but the actions is more than one would expect as the formulations taught by the present invention, result in an unexpected synergistic effect.

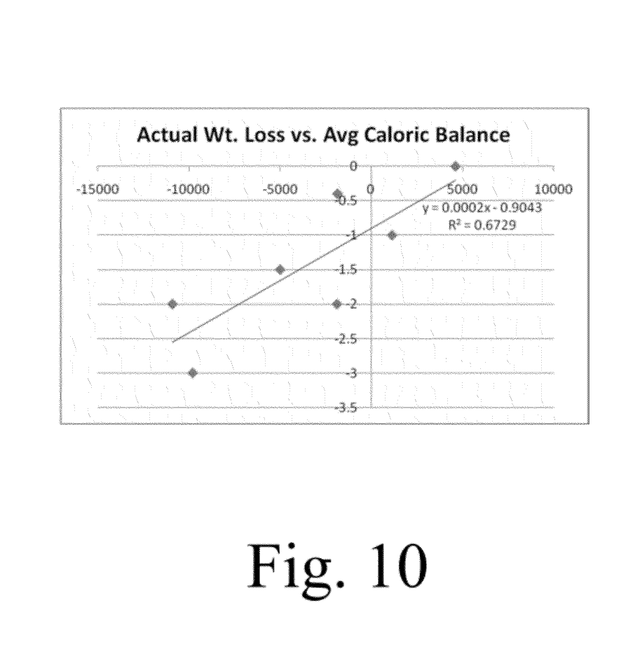

Also supportive of the unexpected results is the relationship between caloric balance and weight loss, which suggests the formulations of the present invention have an effect on increasing the metabolic rate as shown in the results of FIG. 10.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A diet formulation comprising:
a base of Green Tea Extract (standardized 50% EGCG);
a standardized level of caffeine from coffee beans or coffee bean extract;
a blend of B-vitamins;
one of either of the following:
Coleus Forskohlii (4:1, 10:1 ethanol/water, or standardized 10% forskolin) extract, or
one of the following: 5-hydroxtryptophan, or phenethylamine.

2. The diet formulation of claim 1 further comprising:
yohimbe bark extract standardized to 6% yohimbine, or gugglesterones.

3. The diet formulation of claim 1 further comprising:
2g-5g of any of the following glycomannans: fenugreek gum, tara gum, or locus bean gum divided.

4. The diet formulation of claim 1 further comprising:
a base of Green Tea Extract (standardized 50% EGCG) provided in an amount of 900 mg/day with a dose range of 400-1,400 mg/day used to increase BMR and/or lipid metabolism by the liver;
B-vitamins in an amount of 1.1-1.2 mg/day of thiamin;
1. 1-1.3 mg/day of riboflavin;
14-16 mg/day of niacin with a dose range of 0.6-1.8 mg/day of thiamin;
0.6-1.8 mg/day of riboflavin, and 8-24 mg/day of niacin used as an enhancer;
Coleus Forskohlii (4:1, 10:1 ethanol/water, or standardized 10% forskolin) extract in an amount of 500 mg/day with a dose range of 250-750 mg/day used to increase body composition, testosterone levels, metabolic rate;
Coleus Forskohlii (4:1, 10:1 ethanol/water, or standardized 10% forskolin;
Caffeine from coffee beans or coffee bean extract in the amount of 200 mg/day with a dose range of 100-300 mg/day used as a suppressant;
5-Hydroxytryptophan in an amount of 200 mg/day with a dose range of 100-300 mg/day used as an enhancer and suppressant; and
Milk Thistle standardized at 80% silymarin in an amount of 300 mg/day with a dose range of 150-450 mg/day used to promote a healthy liver.

5. The diet formulation of claim 1 further comprising:
Green Tea Extract (standardized 50% EGCG) provided in an amount of 900 mg/day with a dose range of 400-1,400 mg/day used to increase BMR and/or lipid metabolism by the liver;
B-vitamins in an amount of 1.1-1.2 mg/day of thiamin, 1.1-1.3 mg/day of riboflavin, and 14-16 mg/day of niacin with a dose range of 0.6-1.8 mg/day of thiamin, 0.6-1.8 mg/day of riboflavin, and 8-24 mg/day of niacin used as an enhancer;
Coleus Forskohlii (4:1, 10:1 ethanol/water, or standardized 10% forskolin) in an amount of 500 mg/day with a dose range of 250-750 mg/day used to increase BMR;
Caffeine from coffee beans or coffee bean extract in the amount of 200 mg/day with a dose range of 100-300 mg/day used as a suppressant;
Phenethylamine in an amount of 600 mg/day with a dose range of 200-1000 mg/day used as an enhancer and suppressant; and
Milk Thistle in an amount of 300 mg/day with a dose range of 150-450 mg/day used to promote a healthy liver.

6. The diet formulation of claim 2 further comprising:
Green Tea Extract (standardized 50% EGCG) provided in an amount of 900 mg/day with a dose range of 400-1,400 mg/day used to increase BMR;
B-vitamins in an amount of 1.1-1.2 mg/day of thiamin, 1.1-1.3 mg/day of riboflavin, and 14-16 mg/day of niacin with a dose range of 0.6-1.8 mg/day of thiamin, 0.6-1.8mg/day of riboflavin, and 8-24 mg/day of niacin used as an enhancer;
Coleus Forskohlii (4:1, 10:1 ethanol/water, or standardized 10% forskolin) in an amount of 500 mg/day with a dose range of 250-750 mg/day used to increase BMR;
Caffeine from coffee beans or coffee bean extract in the amount of 200 mg/day with a dose range of 100-300 mg/day used as a suppressant;
5-Hydroxytryptophan in an amount of 200 mg/day with a dose range of 100-300 mg/day used as an enhancer and suppressant; and
Yohimbe Bark (standardized 6% yohimbine) in an amount of 667 mg/day with a dose range of 333-1000 mg/day used as a suppressant.

7. The diet formulation of claim 2 further comprising:
Green Tea Extract provided in an amount of 900 mg/day with a dose range of 400-1,400 mg/day used to increase BMR;
B-vitamins in an amount of 1.1-1.2 mg/day of thiamin, 1.1-1.3 mg/day of riboflavin, and 14-16 mg/day of niacin with a dose range of 0.6-1.8 mg/day of thiamin, 0.6-1.8 mg/day of riboflavin, and 8-24 mg/day of niacin used as an enhancer;
Coleus Forskohlii (4:1, 10:1 ethanol/water, or standardized 10% forskolin) in an amount of 500 mg/day with a dose range of 250-750 mg/day used to increase BMR;
Caffeine from coffee beans or coffee bean extract in the amount of 200 mg/day with a dose range of 100-300 mg/day used as a suppressant;
5-Hydroxytryptophan in an amount of 200 mg/day with a dose range of 100-300 mg/day used as an enhancer and suppressant;
Yohimbe Bark in an amount of 667 mg/day with a dose range of 333-1000 mg/day used as a suppressant; and
Fenugreek in an amount of 2 g/day with a dose range of 2-8 g/day used as an absorbent.

8. The diet formulation of claim 1 wherein the formulation is divided into a plurality of doses per day.

9. The diet formulation of claim 8 wherein the formulation is divided into two or three doses per day.

10. The diet formulation of claim 1 wherein
the Green Tea Extract is provided with total catechin content ranging from 300 mg to 900 mg/day in divided doses of 2 or 3;
the category includes epigallocatechin gallate (EGCG), epigallocatechin (EGC), epicatechin gallate (ECG) and epicatechin (EC), of which, EGCG is standardized to 50% or more of the total amount.

11. The diet formulation of claim 1 wherein the B-Vitamin blend includes Niacin, Thiamin, and Riboflavin.

12. The diet formulation of claim 1 wherein
the B-Vitamin blend is provided with or without vitamin B-6, at the 0.6-1.8 mg/day of thiamin, 0.6-1.8 mg/day of riboflavin, and 8-24 mg/day of niacin.

13. The diet formulation of claim 1 wherein the Coleus Forskohlii Extract is provided covering 4:1, 5:1, 10:1 extractions, as well as, standardized extractions of 10% forskolin at doses ranging from 250-750 mg/d.

14. The diet formulation of claim 2 wherein Guggulsterones are provided with a range of 1-2 g/day of extract, typically 2.5-5.0% guggulsterones.

15. The diet formulation of claim 1 wherein Caffeine from coffee beans or coffee bean extract is provided with a range of 50-150 mg/dose up to 100-300 mg/day.

16. The diet formulation of claim 1 wherein 5-Hydroxytryptophan (5-HTP) is provided with a range of 100-900 mg/day.

17. The diet formulation of claim 1 wherein Phenethylamine (PEA) is provided with a range of 200-1000 mg/day.

18. The diet formulation of claim 2 wherein Yohimbe Bark extract (Pausinystalia yohimbe) is provided with a range of 333-1000 mg/day standardized 6% yohimbine.

19. The diet formulation of claim 1 wherein Galactomannans are provided with a range of 1-8 g/day.

20. The diet formulation of claim 1 further comprising Milk Thistle extract (Silybum marianum) in a range of 150-450 mg/day standardized 80% silymarin.
